(19) United States
(12) Patent Application Publication
(10) Pub. No.: US 2019/0331946 A1
(43) Pub. Date: Oct. 31, 2019

(54) LIGHT-ADJUSTING DEVICE AND LIGHT-ADJUSTING METHOD THEREOF

(71) Applicant: SHENZHEN GUOHUA OPTOELECTRONICS CO., LTD., Shenzhen, Guangdong (CN)

(72) Inventors: Guofu ZHOU, Shenzhen, Guangdong (CN); Yuanyuan ZHAN, Shenzhen, Guangdong (CN); Dirk Jan BROER, Shenzhen, Guangdong (CN); Danqing LIU, Shenzhen, Guangdong (CN); Albertus Petrus Henricus Johannes SCHENNING, Shenzhen, Guangdong (CN)

(73) Assignee: SHENZHEN GUOHUA OPTOELECTRONICS CO., LTD., Shenzhen, Guangdong (CN)

(21) Appl. No.: 16/475,918

(22) PCT Filed: Jul. 6, 2018
(86) PCT No.: PCT/CN2018/094860

§ 371 Date: Jul. 3, 2019

(30) Foreign Application Priority Data
Aug. 18, 2017 (CN) 201710713555.4

(51) Int. Cl. G02F 1/1337; G09G 3/36

(52) U.S. Cl. CPC G02F 1/1337; G09G 3/36; G02F 2001/133773; G02F 2001/133796; G09G 2360/14

(57) ABSTRACT

A light-adjusting device and a light-adjusting method thereof are disclosed. A main liquid crystal and salt from which ions are ionized are filled between adjusting areas formed by oppositely arranged substrates, the main liquid crystal is arranged in a specific orientation under an induction of an alignment layer under an unpowered state, the main liquid crystal is re-oriented under an powered state, meanwhile, ions ionized from the salt from which ions are ionized move quickly under an effect of an formed electric field, which disorganizes the specific orientation arrangement of the main liquid crystal, so that the main liquid crystal moves irregularly following a quick movement of the ionized ions, so as to scatter incident light in a visible light band, and further adjust transmission and scattering of visible light, thus realizing light adjustment.

### CROSS-REFERENCE TO RELATED APPLICATIONS

This application is a national phase application of International Application No. PCT/CN2018/094860, filed Jul. 6, 2018, which claims priority to CN 201710713555.4, filed Aug. 18, 2017, all of which are hereby incorporated herein by reference.

### TECHNICAL FIELD

The present disclosure relates to the field of display technologies, and more particularly, to a light-adjusting liquid crystal device and a driving method thereof.

### BACKGROUND

In recent years, an intelligent light-adjusting window has attracted the interest and attention of scientists because it can be switched between transparent and non-transparent states. Under normal circumstances, the intelligent window is in a transparent natural state to keep the indoor bright with day light; and under a powered state, the window may be adjusted to be non-transparent, but light may still pass through the window to keep the indoor bright. Therefore, the intelligent window may replace a curtain to have a function of isolating and protecting privacy, and has gradually entered the China market.

Most of the existing intelligent windows are based on a polymer network system, due to the high costs of polymer materials, the price of the intelligent window has remained relatively high, and the price is currently several thousand yuan per square meter. At present, a polymer dispersed liquid crystal (PDLC) system, also called light-adjusting liquid crystal film, is mainly used. PDLC is prepared by photopolymerizing liquid crystal monomer mixture under irradiation of ultraviolet light. After polymerization, micron-sized liquid crystal droplets are uniformly dispersed in the polymer network. Under the stimulation of an applied electric field, liquid crystal molecules with dielectric anisotropy tend to be reoriented by the field, which leads to mismatch of refractive index between non-reactive liquid crystal molecules and polymer network. Therefore, the system can be switched between a scattering state and a transparent state. However, the PDLC system requires a polymerization process for the liquid crystal monomer to form the polymer network, which takes a long time and has high production cost, and moreover, due to an aging phenomenon of an organic polymer, a service life of the intelligent window is greatly reduced.

### SUMMARY

The object of the present disclosure is to provide a polymer-free light-adjusting device to solve the problems of high cost and short service life caused by using a polymer network in the prior art.

The technical solutions adopted in the present disclosure are as follows.

The present disclosure provides a light-adjusting device, which comprises two oppositely arranged substrates, each comprises a light-transmitting substrate, a conducting layer and an alignment layer, sequentially arranged, the alignment layers of the two substrates are oppositely arranged, an adjusting area is formed between the two substrates, a liquid crystal mixture is filled in the adjusting area, the liquid crystal mixture comprises a main liquid crystal with dielectric anisotropy and salt from which ions are ionized.

In some implementations, the main liquid crystal is a negative liquid crystal, and the alignment layer is a vertical alignment layer.

In some other implementations, the main liquid crystal is a positive liquid crystal, and the alignment layer is a parallel alignment layer.

Further, the alignment layer is a polyimide alignment layer.

The salt from which ions are electrolyzed is a quaternary ammonium salt surfactant.

Further, the salt from which ions are ionized is a quaternary ammonium salt cationic surfactant.

Further, the quaternary ammonium salt is at least one of tetrabutylammonium hexafluorophosphate, tetrabutylammonium perchlorate, hexadecyl trimethyl ammonium bromide and dodecyltrimethylammonium bromide.

In one implementation, the liquid crystal mixture comprises 90.0 wt % to 99.99 wt % of the main liquid crystal and 0.01 wt % to 10.0 wt % of the salt from which ions are electrolyzed.

In one implementation, the adjusting area has a height of 5 μm to 50 μm.

In one implementation, the adjusting area is also filled with a spacer for supporting the height of the adjusting area.

In one implementation, the light-adjusting device further comprises a power supply component, wherein two poles of the power supply component are electrically connected with the two conducting layers respectively.

Further, a working voltage of the power supply component is 7 V to 50 V.

Further, a working frequency of the power supply component is 50 Hz to 1000 Hz.

The present disclosure further provides a light-adjusting method for the light-adjusting device above, light-adjusting method comprises by applying an AC voltage, converting the main liquid crystal from an vertical orientation arrangement to an parallel orientation arrangement, with respect to the substrate, and causing the salt from which ions are ionized to move under a formed AC electric field to disorganize the orientation arrangements of the main liquid crystal, thereby to adjust transmission and scattering of visible light for light adjustment.

The present disclosure has the beneficial effects as follow.

The present disclosure provides a light-adjusting device, in an unpowered state, the main liquid crystal is in a specific orientation arrangement under induction of the alignment layer, in a powered state, the main liquid crystal is subjected to reorientation arrangement, and meanwhile, ions ionized by the salt from which ions are ionized rapidly move under an effect of the formed electric field, which disorganizes the reorientation arrangement of the main liquid crystal, so that main liquid crystal molecules move irregularly along with the rapid movement of the ionized ions. A very small amount of impurities contained in the main liquid crystal itself can also cause electrodynamic instability along with the reorientation arrangement of the main liquid crystal, and the ions formed by excitation of the alignment layer by the electric field can also participate in the electrodynamic instability, thus aggravating the change of the main liquid crystal from the specific orientation arrangement to irregular arrangement, scattering incident light in a visible light waveband, and further adjusting transmission and scattering of visible light, so as to adjust light. On the premise that the light-adjusting liquid crystal device provided by the present disclosure achieves light adjustment, since the system does not have the polymer network, the main liquid crystal and the salt from which ions are ionized can be directly mixed and filled into the liquid crystal cell, so that the preparation process is simple without needing a reaction monomer and a polymerization process, and having no polymer aging phenomenon, thus reducing the production cost and extending the service life of the light-adjusting liquid crystal device.

### BRIEF DESCRIPTION OF THE DRAWINGS

FIG. 1 illustrates a light-adjusting device under an unpowered state; and

FIG. 2 illustrates a light-adjusting device under a powered state.

### DETAILED DESCRIPTION

The conception, specific structure and generated technical effects of the present disclosure will be clearly and completely described hereinafter with reference to the implementations and the drawings to fully understand the objects, features and effects of the present disclosure. Apparently, the described implementations are only some implementations of the present disclosure rather than all the implementations, and other implementations obtained by those skilled in the art based on the implementations of the present disclosure without going through any creative works shall all fall within the protection scope of the present disclosure.

First Implementation

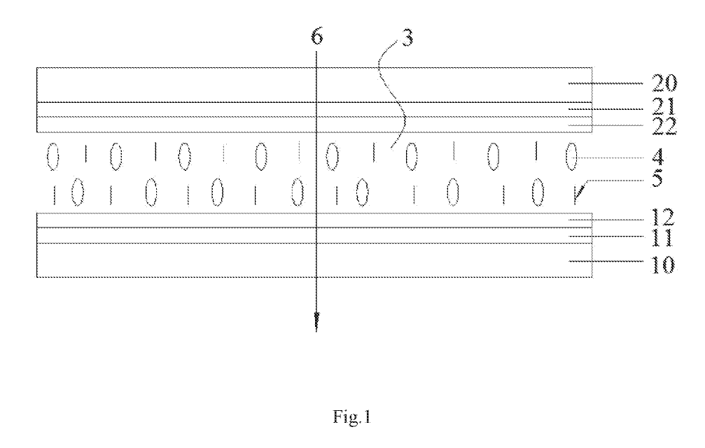

With reference to FIG. 1, the present disclosure provides a light-adjusting device, which comprises a first substrate and a second substrate which are oppositely arranged, wherein the first substrate comprises a first transparent glass substrate 10, a first ITO conducting layer 11 and a first polyimide vertical-alignment layer 12 which are sequentially arranged, the second substrate comprises a second transparent glass substrate 20, a second ITO conducting layer 21 and a second polyimide vertical-alignment layer 22 which are sequentially arranged, the first polyimide vertical-alignment layer 12 of the first substrate and the second polyimide vertical-alignment layer 22 of the second substrate are oppositely arranged, an adjusting area 3 is formed between the first substrate and the second substrate, a height of the adjusting area 3 is 5 μm, a liquid crystal mixture is filled into the adjusting area 3, the liquid crystal mixture comprises a negative liquid crystal 4 and tetrabutylammonium perchlorate 5, a mass fraction of the tetrabutylammonium perchlorate 5 in the liquid crystal mixture is 0.01%, in an unpowered state, the negative liquid crystal 4 is in orientation arrangement perpendicular to the transparent glass substrate under induction of the polyimide vertical-alignment layer, and visible light 6 may be transmitted out of the transparent glass substrate, thus presenting a light-transmitting state.

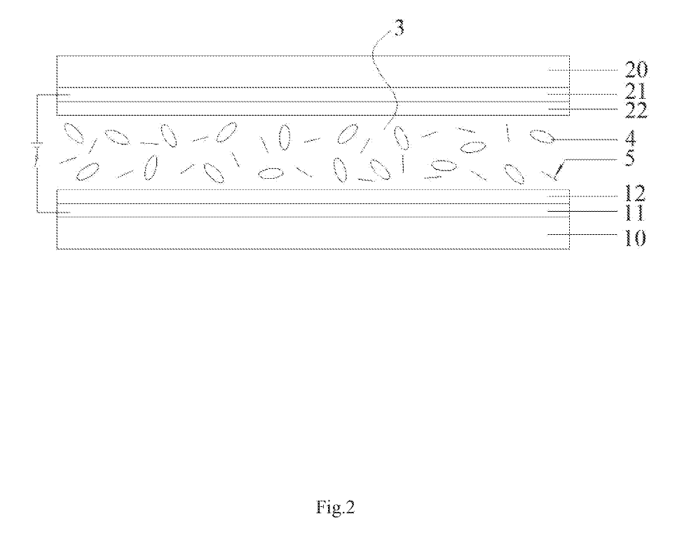

The present disclosure further provides a light-adjusting method for the light-adjusting device above. As shown in FIG. 2, when the light-adjusting liquid crystal component is connected with a power supply component with a voltage of 30 V and a frequency of 50 Hz in a powered state, the negative liquid crystal is controlled to be reoriented by an applied AC voltage, changing from the orientation arrangement perpendicular to the transparent glass substrate to orientation arrangement parallel to the transparent glass substrate, tetrabutyl perchlorate ions and ammonia ions rapidly move under an effect of a formed AC electric field, which disorganizes the reorientation arrangement of the negative liquid crystal, so that negative liquid crystal molecules move irregularly along with the rapid movement of the tetrabutyl perchlorate ions and the ammonia ions, and meanwhile, a very small amount of impurities contained in the negative liquid crystal may also cause electrodynamic instability along with the reorientation arrangement of the negative liquid crystal, and the ions formed by excitation of the alignment layer by the electric field may also participate in the electrodynamic instability, thus aggravating the change of the negative liquid crystal from the specific orientation arrangement to irregular arrangement, and controlling transmission and scattering of visible light, so as to realize light adjustment. In a powered state according to the implementation, a light transmittance of the light-adjusting liquid crystal device above is 8% at 500 nm. Since the filled liquid crystal mixture has only small molecules, a working voltage for driving the light-adjusting device provided by the present disclosure is smaller than that of the device based on the polymer network, so that the light-adjusting device may be driven by alternating current of household appliance in life without needing equipment of special frequency, thus being convenient to put into household. Since a phenomenon that migration of a reaction monomer disorganizes molecular arrangement in the polymerization process does not exists, molecular orientation of a mixture of the main liquid crystal molecules and the quaternary ammonium salt molecules in the system is regular, the light-adjusting liquid crystal device presents a light-transmitting state in a natural state, and a transmittance of the light-adjusting liquid crystal device may be less than 10% after being powered.

The implementation takes the tetrabutylammonium perchlorate as an example to illustrate, and actually, quaternary ammonium salts such as tetrabutylammonium hexafluorophosphate, hexadecyl trimethyl ammonium bromide and dodecyltrimethylammonium bromide may be added. Quaternary ammonium salt powder is pure white, thus avoiding a problem that a transparency of the light-adjusting device is affected by colors of impurities, enabling the main liquid crystal to be uniformly mixed without phase separation, and avoiding air bubbles in the light-adjusting device caused by phase separation and other problems, and the quaternary ammonium salt has a stable property and does not generate an electrochemical reaction with electrodes, thus avoiding a problem of reducing a service life of the light-adjusting device due to the electrochemical reaction. The light-adjusting liquid crystal device provided by the present disclosure may be applied to, but is not limited to, intelligent windows for residential applications or projection hard screens for commercial applications.

Second Implementation

The implementation provides a light-adjusting device, which has a structure same as that of the first implementation, but differs in that a height between the adjusting areas is 50 μm, the liquid crystal mixture is a negative liquid crystal and hexadecyl trimethyl ammonium bromide, a mass fraction of the hexadecyl trimethyl ammonium bromide in the liquid crystal mixture is 10%, and the light-adjusting liquid crystal device is connected with a power supply component with a voltage of 7 V and a frequency of 50 Hz in a powered state.

Third Implementation

The implementation provides a light-adjusting device, which has a structure same as that of the first implementation, but differs in that a height between the adjusting areas is 25 μm, the liquid crystal mixture is a positive liquid crystal and dodecyltrimethylammonium bromide, a mass fraction of the dodecyltrimethylammonium bromide in the liquid crystal mixture is 5%, the alignment layer is a polyimide parallel-alignment layer, and the light-adjusting liquid crystal device is connected with a power supply component with a voltage of 25 V and a frequency of 1000 Hz in a powered state. For the light-adjusting device provided by the implementation in an unpowered state, a positive liquid crystal is subjected to orientation arrangement parallel to the substrate under induction of the polyimide parallel-alignment layer, when the power supply component is connected to be in a powered state, the positive liquid crystal is controlled to be reoriented by the applied AC voltage, changing from the orientation arrangement parallel to the transparent glass substrate to the orientation arrangement perpendicular to the transparent glass substrate, and meanwhile, cation and anion ions ionized by dodecyltrimethylammonium bromide rapidly move under an effect of the formed AC electric field, which disorganizes the reorientation arrangement of positive liquid crystal, so that positive liquid crystal molecules move irregularly along with the rapid movement of the cation and anion ions. Meanwhile, a very small amount of impurities contained in the positive liquid crystal may also cause electrodynamic instability along with the reorientation arrangement of the positive liquid crystal, and the ions formed by excitation of the alignment layer by the electric field may also participate in the electrodynamic instability, thus further aggravating the change of the positive liquid crystal from the specific orientation arrangement to irregular arrangement, and controlling transmission and scattering of visible light, so as to adjust light.

Fourth Implementation

The implementation provides a light-adjusting device, which has a structure same as that of the first implementation, but differs in that a height between the adjusting areas is 10 μm, the liquid crystal mixture is a negative liquid crystal and tetrabutylammonium hexafluorophosphate, a mass fraction of the tetrabutylammonium hexafluorophosphate in the liquid crystal mixture is 1%, and the light-adjusting liquid crystal device is connected with a power supply component with a voltage of 50 V and a frequency of 100 Hz to be in a powered state.

1. A light-adjusting device, comprising:
two oppositely arranged substrates, each comprising a light-transmitting substrate, a conducting layer and an alignment layer, sequentially arranged, wherein the alignment layers of the two substrates are oppositely arranged;
an adjusting area, formed between the two substrates;
a liquid crystal mixture, filled in the adjusting area, and comprising a main liquid crystal with dielectric anisotropy and salt from which ions are ionized.

2. The light-adjusting device of claim 1, wherein the main liquid crystal is a negative liquid crystal, and the alignment layer is a vertical alignment layer.

3. The light-adjusting device of claim 1, wherein the main liquid crystal is a positive liquid crystal, and the alignment layer is a parallel alignment layer.

4. The light-adjusting device of claim 1, wherein the salt from which ions are ionized is a quaternary ammonium salt surfactant.

5. The light-adjusting device of claim 4, wherein the quaternary ammonium salt is at least one of tetrabutylammonium hexafluorophosphate, tetrabutylammonium perchlorate, hexadecyl trimethyl ammonium bromide and dodecyltrimethylammonium bromide.

6. The light-adjusting device of claim 1, wherein the liquid crystal mixture comprises 90.0 wt % to 99.99 wt % of the main liquid crystal and 0.01 wt % to 10.0 wt % of the salt from which ions are ionized.

7. The light-adjusting device of claim 1, wherein the adjusting area has a height of 5 μm to 50 μm.

8. The light-adjusting device of claim 1, wherein the adjusting area is also filled with a spacer for supporting the height of the adjusting area.

9. The light-adjusting device of claim 1, further comprising a power supply component, wherein two poles of the power supply component are electrically connected with the two conducting layers respectively.

10. A light-adjusting method for the light-adjusting device of claim 1, comprising:
converting the main liquid crystal, by applying an AC voltage, from an vertical orientation arrangement to an parallel orientation arrangement, with respect to the substrate, and
causing the salt from which ions are ionized to move under a formed AC electric field to disorganize the orientation arrangements of the main liquid crystal, thereby to adjust transmission and scattering of visible light for light adjustment.

11. The light-adjusting device of claim 2, wherein the liquid crystal mixture comprises 90.0 wt % to 99.99 wt % of the main liquid crystal and 0.01 wt % to 10.0 wt % of the salt from which ions are ionized.

12. The light-adjusting device of claim 3, wherein the liquid crystal mixture comprises 90.0 wt % to 99.99 wt % of the main liquid crystal and 0.01 wt % to 10.0 wt % of the salt from which ions are ionized.

13. The light-adjusting device of claim 4, wherein the liquid crystal mixture comprises 90.0 wt % to 99.99 wt % of the main liquid crystal and 0.01 wt % to 10.0 wt % of the salt from which ions are ionized.

14. The light-adjusting device of claim 5, wherein the liquid crystal mixture comprises 90.0 wt % to 99.99 wt % of the main liquid crystal and 0.01 wt % to 10.0 wt % of the salt from which ions are ionized.

15. The light-adjusting device of claim 2, wherein the adjusting area is also filled with a spacer for supporting the height of the adjusting area.

16. The light-adjusting device of claim 3, wherein the adjusting area is also filled with a spacer for supporting the height of the adjusting area.

17. The light-adjusting device of claim 4, wherein the adjusting area is also filled with a spacer for supporting the height of the adjusting area.

18. The light-adjusting device of claim 5, wherein the adjusting area is also filled with a spacer for supporting the height of the adjusting area.

19. The light-adjusting device of claim 2, further comprising a power supply component, wherein two poles of the power supply component are electrically connected with the two conducting layers respectively.

20. The light-adjusting device of claim 3, further comprising a power supply component, wherein two poles of the power supply component are electrically connected with the two conducting layers respectively.
